(19) United States
(12) Patent Application Publication
(10) Pub. No.: US 2008/0047522 A1
(43) Pub. Date: Feb. 28, 2008

(54) Low fuel shut off for a portable welder generator

(75) Inventors: John C. Leisner, Appleton, WI (US); Daniel C. Fosbinder, Appleton, WI (US)

Correspondence Address: Patrick S. Yoder;FLETCHER YODER, P.O. Box 692289, Houston, TX, 77269-2289, US

(73) Assignee: Illinois Tool Works Inc.

(21) Appl. No.: 11/511,025

(22) Filed: Aug. 28, 2006

(51) Int. Cl. F02D 17/04; B23K 9/10; F02M 17/30; B60Q 1/00

(52) U.S. Cl. 123/198 D; 123/198 DB; 340/438; 219/133

(57) ABSTRACT

A low fuel shut off for a portable engine-driven welder is disclosed that disables the engine when the fuel level drops below a desired level. The system includes a controller configured to receive the current fuel level signal from a fuel sensor positioned in or near the fuel tank. The controller is connected to a maintenance display that may include a fuel gauge, a visual alarm, and an audible alarm. The controller regulates the fuel supply by actuating a valve and closing the valve when the fuel level drops below the desired level. The low fuel shut off works in conjunction with a visual and/or an audible alarm alerting the operator before and/or after the engine is disabled. The controller is configured to receive data from other engine sensors and can disable the engine if the parameters reach a specified level.

### BACKGROUND

The invention relates generally to the field of portable engine-driven welders. More specifically, the invention relates to a low fuel shut off for a diesel engine that is used in the operation of an engine-driven welder. The low fuel shut off operates in conjunction with an audible and/or visual alarm.

Portable-engine-driven generators are commonly used to provide electrical power in locations where conventional electrical power is not readily available. Both gasoline and diesel engines are used to drive such generators, and the power produced is typically either 120 VAC or 240 VAC. One specific generator application is for welding processes, and these units are commonly known as portable engine-driven welders. These units include a control system to regulate the power produced by the generator thereby making it suitable for an arc welding, plasma cutting and similar operations. Typical welding operations for which these units are intended include stick electrode welding, MIG welding, and TIG welding.

Engine-driven welders often incorporate a diesel engine as the drive mechanism because these engines typically use 20%-35% less fuel, have 1-½ to 2 times the engine life, and are required at job sites to meet OSHA regulations or other standards. One issue with using a diesel engine in this application is the difficulty in restarting the engine after the fuel supply has been completely depleted, also known as running the engine dry. The difficulty can be attributed to the difference in the combustion cycle of a diesel engine versus a gasoline engine. A gasoline engine intakes a mixture of gasoline and air, compresses the mixture and then ignites the mixture with a spark. A diesel engine, on the other hand, takes in air only, compresses the air, and then injects the fuel into the compressed air which ignites the fuel spontaneously by virtue of the compression in the engine cylinders.

Those skilled in the art will appreciate that running a diesel engine dry introduces air into the fuel supply and injection system. The result is the air to fuel mixture becomes imbalanced, thereby inhibiting the combustion process and preventing the diesel engine from starting. In addition, the higher compression ratio of the diesel engine provides significantly more engine braking than does a gasoline engine, thus making the engine even more difficult to initially crank. Therefore, the imbalance in the air to fuel mixture makes starting the engines very difficult and results in excessive cranking of the engine. Excessive cranking is undesirable because it can damage the ignition and starting system and other engine components.

Many diesel engines, once run dry, require performing the laborious task of bleeding the fuel line and injectors before the engine can be restarted. Bleeding the fuel line consists of purging air from the fuel system. Generally speaking, this involves opening the fuel line and pumping fuel through the system until all of air has been displaced. This can be a time consuming operation, and requires that the operator know exactly how to perform it. Furthermore, access to these components is often limited by an enclosure, making the task even more time-consuming and difficult to perform.

There is a need for a system that can avoid these difficulties with diesel engines, particularly for welders. In welding applications, the operator may not be able to monitor the fuel level, particularly insomuch as the operator is rarely close to the power supply, and may work for extended periods as some distance, that is, at the location of the work piece. Moreover, the welding operator clearly must carefully focus on the welding operation, and may not be able to direct sufficient attention to such issues as the engine fuel supply level. There is an inherently increased risk of running a diesel engine dry in such situations.

### BRIEF DESCRIPTION

The current invention offers the novel solution to low fuel shut off for a diesel engine used for generator and welding power supplies when the fuel level drops below a desired level. The invention includes a controller configured to receive the current fuel level via a fuel sensor positioned in or near a fuel tank. The controller is connected to a maintenance display thereby providing feedback to the operator. The maintenance display may include a fuel gauge, a visual alarm, and/or an audible alarm. The controller may regulate the fuel supply to the engine by actuating a valve to disable the engine if the fuel level drops below the desired level. Thus, in one aspect the current invention operates as an automatic low fuel shut off for an engine-driven welder. The low fuel shut off may work in conjunction with a visual and/or an audible alarm alerting the operator before and after the engine is disabled. Furthermore, the controller may be configured to receive data from other engine sensors. These sensors may include a temperature transducer communicating coolant temperature and a pressure transducer communicating oil pressure. The controller can similarly notify the operator and disable the engine if these or other important engine parameters reach a critical level. In this aspect, the current invention acts as an automatic engine shut off and alarm when engine parameters reach a critical level.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an engine-driven welder incorporating engine disabling features in accordance with aspects of the invention;

FIG. 2 is a front elevational view of the engine-driven welder of FIG. 1, viewed from line 2-2 of FIG. 1 and illustrating a control panel that includes the maintenance display and other control elements;

FIG. 3 is a block diagram functionally illustrating the low fuel shut-off and other functional maintenance sensors;

FIG. 4 is an illustration of an exemplary application of an engine-driven welder and demonstrating the operation of the inventive system in situations where the operator is at a location remote from the unit and is not in a position to continually monitor the maintenance displays.

### DETAILED DESCRIPTION

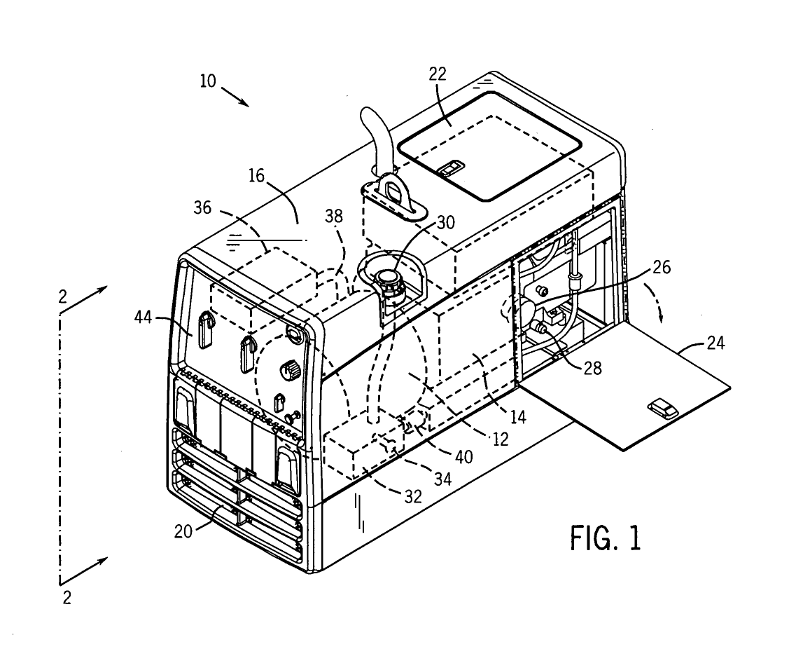

Turning now to the drawings, FIG. 1 illustrates the location of the respective elements of an exemplary engine-driven welder. The engine-driven welder 10 includes an electrical power generator 12 that is coupled to and driven by an engine 14. In the illustrated embodiment, the engine is a diesel engine. The engine and generator are fully enclosed by an enclosure 16. The enclosure protects the engine and generator form dust, debris, and so forth. The enclosure also reduces noise and helps to cool the engine by preventing hot air recirculation via the cool air inlet 20 pulling air through the interior volume of the enclosure. The enclosure incorporates panels allowing the operator to access the engine. A top panel 22 provides access to the top of the engine and allows the operator to perform such maintenance tasks as adding coolant. A side panel 24 allows the user to access the side of the engine where the oil filter 26 and oil drain 28 are located. Even though the panels do provide access to the engine, those skilled in the art will appreciate that the difficulty of bleeding the fuel system is complicated given that access to engine is limited by the enclosure.

The enclosure incorporates a fuel inlet 30 allowing the operator to fill the fuel tank 32. A fuel sensor 34 is positioned in or near the tank and communicates a fuel level signal to an engine controller 36. The fuel sensor can be a mechanical float that operates an electronic transducer or a density sensor located on the side of the tank that sends an electrical signal to the controller via a conductor 38. Other types of sensor arrangements may also be employed. The present embodiment incorporates a resistive sending unit that sends a voltage to the controller via an electrical conductor, whereby the voltage is indicative of the fuel level in the tank.

The controller is coupled to a valve 40 that regulates the fuel supply to the engine. The controller provides a signal to cause valve to close when the fuel supply drops below a desired level, thereby disabling the engine. The valve can be a mechanical device or an electromechanical device (e.g., solenoid-operated valve) and is typically coupled to the controller via an electrical conductor 38. Those skilled in the art will appreciate that this configuration avoids the problem of running the diesel engine dry thereby avoiding the need to service the engine before continuing welding operations.

It should be noted that other mechanisms and schemes may be employed for interrupting fuel flow or disabling the engine in the event the fuel level drops below a specified level. For example, the fuel delivery system may be disabled by disabling a fuel pump (not shown) that provides the fuel flow to the engine. Moreover, control signals used to regulate other operating parameters of the engine may be altered or interrupted to disable the engine.

Furthermore, the controller is configured to receive input from other transducers that measure other important engine parameters. For example, a pressure transducer may monitor the oil pressure, while a temperature transducer may monitor coolant temperature, and relay this data to the controller. The controller can similarly interrupt the fuel supply to the engine, via the valve, if at least one of these engine parameters approaches a specified limit. Those skilled in the art will appreciate that the current invention reduces the possibility of damaging the engine due to a depleted fuel supply, engine overheating, or poor engine lubrication. Thus, the operator is alleviated of the responsibility to continually monitoring these engine parameters because the current invention will automatically respond if one of these parameters reaches an undesired level.

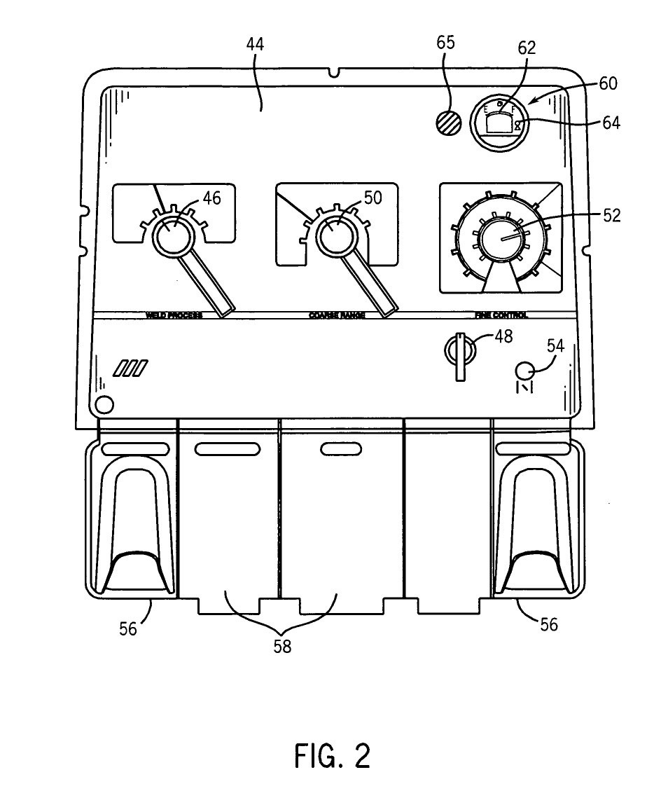

The operator interacts with the controller via a control panel 44. FIG. 2 is a front elevational view of the control panel, viewed from line 2-2 of FIG. 1. In the present embodiment, the control panel is configured with a number of different displays, switches, controls, and receptacles. The switches include a weld process selector switch 46 that allows the operator to select the proper power output for the given welding application; and an engine control switch 48 that is used to start the engine and select between different idle settings. The controls include a coarse range control 50 that allows the operator to select the proper amperage for welding, a fine adjust control 52 that allows the operator to fine tune the amperage, and a engine control 54 that may include a glow plug control for diesel engines. The receptacles include an electrical outlet 56 to connect welding cables to the unit, and power receptacles 58 that allow the operator to connect other electrical loads. Furthermore, the control panel has a maintenance display 60 that provides the operator with an indication of the fuel level via a fuel gauge 62.

In accordance with particular features of the invention, the maintenance display may also notify the operator of a potential engine problem via a visual alarm 64 and/or an audible alarm 65. As discussed above, these potential problems could include low fuel level, low oil pressure, high coolant temperature or any other potentially problematical events. The maintenance display also includes the total engine hours and oil change interval information. Those skilled in the art will appreciate that this maintenance display provides important feedback to the operator. It incorporates elements that notify the operator prior to disabling the engine as well as communicates the reason why the engine was disabled, thereby allowing the operator to quickly address the engine problem.

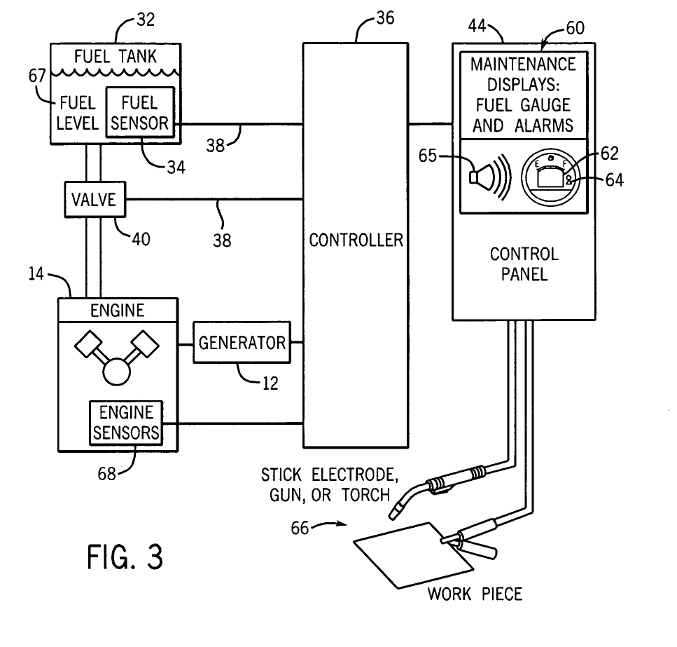

FIG. 3 is a block diagram of the system shown in FIG. 1 and illustrates the functional operation of the current invention. As discussed above, an engine 14 drives a generator 12 the output power of which is regulated by a controller 36. The power is interfaced through the control panel 44 and is used in a welding operation 66 via welding cables interfacing with the control panel. The unit includes a fuel sensor 34 that is located in or near a fuel tank 32. The fuel sensor communicates the fuel level 67 to the controller 36 which displays the fuel level and provides alarms to the operator via the maintenance display 60. The alarms include a visual alarm 64 and/or an audible alarm 65. A valve 40 is positioned between the fuel tank and the engine 14 and regulates the fuel supply to the engine. The valve is actuated by the controller and is closed when the fuel level drops below a desired level, thereby disabling the engine. In addition, engine sensors 68 provide the controller with other important engine parameters, allowing the controller to disable the engine if these parameters approach specified limits. As stated above, FIG. 3 illustrates the functional operation of the current invention, the means of which can be accomplished by a number of different configurations, a few of which were described above. Those skilled in the art will appreciate that this representation functionally captures and illustrates the broad range of means able to implement some of the novel features of the current invention. For example, in some systems, welding power output may be controlled in a closed-loop manner, while other systems may provide open loop welding power output.

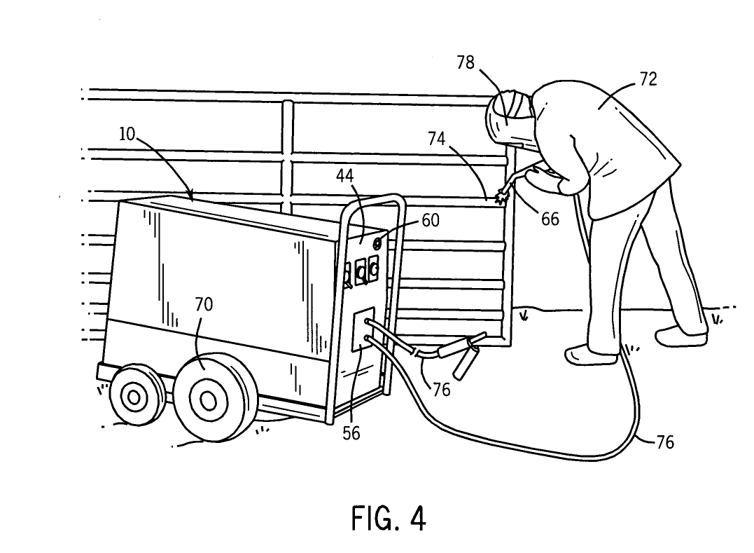

FIG. 4 illustrates an exemplary application of an engine-driven welder, and depicts the unique problem with fuel level monitoring in welding applications. The engine-driven welder 10 is shown positioned on a cart 70 used to transport the unit. In many applications, the welder may, in fact, be positioned in a truck or other work vehicle that can approach the work location, but that is not immediately adjacent to the work piece. An operator 72 is shown performing a welding operation 66 on a work piece 74. In this illustration, the work piece is a metal gate. The work piece and welding equipment are coupled via the electrical outlets 56 and welding cables 76 located on the control panel 44.

As is typical in all welding operations, the operator is shown wearing a welding helmet 78 and other protective welding equipment. Those skilled in the art will appreciate that the current illustration is just one example of many possible welding applications and that it is not uncommon for the operator be even more remotely positioned than is illustrated by the figure. Given this, it becomes apparent why the operator is typically not in a position to continually monitor the fuel level or other engine parameters. Furthermore, the welding operation itself requires the undivided attention of the operator making it difficult to even intermittently monitor the maintenance display 60 even when relatively accessible from the welding location. Moreover, the required protective head gear and other safety equipment further prohibit the operator from monitoring the maintenance display. Thus, unlike other applications involving diesel engine-s, the engine-driven welder is predominately used in applications where it is not only impractical for the operator to continually monitor the maintenance display, but it is also counterproductive or even impossible to do so. Those skilled in the art will appreciate that a benefit of the current invention is that it provides for automatically disabling the engine in conjunction with the visual and/or audible alarm, which can inform a remote welding operator of the need to refuel the generator unit.

An exemplary scenario illustrating how the current invention and an operator might interact may be as follows. The controller signals both a visual and/or audible alarm to alert the operator that the fuel level is dropping below a desired level. If the operator is in a position to detect either the visual and/or audible alarm, then the operator can halt the welding operation and remedy the situation by adding more fuel. If the operator is not in a position to detect either alarm, then the controller will automatically disable the engine, thereby preventing the diesel engine from running completely dry. Furthermore, the controller may also be configured to monitor other engine parameters and to disable the engine or provide a visual and/or audible alarm when these parameters reach a specified level. The result is that the controller removes a significant burden from the operator and improves the operator's overall productivity. As stated above, the nature of the welding operating environment makes this type of scenario a common occurrence. Thus, the current invention has particular benefit and fulfills a long felt need for engine-driven welder applications.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A portable engine-driven welder, comprising:
an electric generator;
an engine coupled to the generator to drive the generator to produce electric power;
a fuel supply tank for storing fuel for the engine;
a fuel sensor for detecting a level of fuel in the fuel tank; and
a controller coupled to the engine for controlling operation of the engine and to the fuel sensor, the controller receiving signals from the sensor indicative of fuel level in the fuel tank and disabling the engine if the fuel level drops below a desired level; and
an audible alarm coupled to the controller for providing notice to a user prior to disabling the engine, the alarm configured to alert the user welding at a location remote from the engine and generator.

2. The portable engine-driven welder of claim 1, comprising a valve coupled to the controller that regulates the fuel supply to the engine and is actuated by the controller based upon the fuel level.

3. The portable engine-driven welder of claim 2, wherein the controller closes the valve to interrupt flow of fuel to the engine if the fuel level drops below the desired level.

4. (canceled)

5. (canceled)

6. The portable engine-driven welder of claim 1, comprising welding cables for delivering welding power to a work piece location remote from the engine and generator.

7. The portable engine-driven welder of claim 1, wherein the fuel sensor includes a mechanical float that operates an electronic transducer.

8. The portable engine-driven welder of claim 1, comprising an electronic gauge coupled to the controller for displaying the level of fuel in the tank and a visual alarm for signaling when the level of fuel reaches a predetermined level.

9. A portable engine-driven welder, comprising:
an electric generator;
an engine coupled to the generator to drive the generator to produce electric power;
a fuel supply tank for storing fuel for the engine;
a fuel sensor for detecting a level of fuel in the fuel tank;
a controller coupled to the engine for controlling operation of the engine and to the fuel sensor, the controller receiving signals from the sensor indicative of fuel level in the fuel tank and disabling the engine if the fuel level drops below a desired level;
welding cables for delivering welding power to a work piece location remote from the engine and generator; and
an audible alarm coupled to the controller for providing notice to a user welding at a location remote from the engine and generator prior to disabling the engine.

10. The portable engine-driven welder of claim 9, wherein the alarm is an audible alarm configured to provide notice to a user welding at the location remote from the engine and generator.

11. The portable engine-driven welder of claim 9, comprising a valve coupled to the controller that regulates the fuel supply to the engine and is actuated by the controller based upon the fuel level.

12. The portable engine-driven welder of claim 11, wherein the controller closes the valve to interrupt flow of fuel to the engine if the fuel level drops below the desired level.

13. The portable engine-driven welder of claim 9, comprising an electronic gauge coupled to the controller for displaying the level of fuel in the tank and a visual alarm for signaling when the level of fuel reaches a predetermined level.

14. A method for controlling a portable engine-driven welder, comprising:
generating electrical power via a generator driven by an engine;
providing the electrical power to a work piece location remote from the engine and generator via welding cables;
delivering fuel to the engine from a fuel tank;
detecting a level of fuel in the fuel tank; and
disabling the engine if the fuel level drops below a desired level; and
generating an audible alarm of sufficient magnitude to alert a user, welding at a location remote from the engine and generator, of a change in fuel level.

15.-18. (canceled)

19. The method of claim 14, wherein disabling the engine includes interrupting a flow of fuel to the engine.

20. The method of claim 14, further comprising displaying a visual indication of the level of fuel in the tank and a visual alarm indicating that the engine has been disabled due to the level of fuel in the fuel tank.

21. The method of claim 14, wherein the change in fuel level comprises the fuel reaching a level where the engine will be disabled.
